(19) United States
(12) Patent Application Publication
(10) Pub. No.: US 2003/0233060 A1
(43) Pub. Date: Dec. 18, 2003

(54) Automatic massage device

(76) Inventor: He-Chun Liu, Taichung (TW)

Correspondence Address: He-Chun Liu, 58, MA YUAN WEST ST., TAICHUNG, TW

(21) Appl. No.: 10/176,514

(22) Filed: Jun. 18, 2002

(51) Int. Cl. A61H 23/02

(52) U.S. Cl. 601/111

(57) ABSTRACT

An automatic massage device has a base panel, a transmission mechanism, and a rocking mechanism. The transmission mechanism has a motor, two gears, two generally S-shaped push plates, two driven shafts, and the motor having a first main shaft connected to a first worm and a second main shaft connected to a second worm. Each driven shaft passes through the corresponding generally S-shaped push plate, and the corresponding gear. The rocking mechanism has two rocking plates, two pivot shafts, two controlling plates, two expansion springs, two chucks, two roller wheels, and two platforms. Each expansion spring is connected to the base panel and the corresponding controlling plate. Each driven shaft passes through the corresponding rocking plate, and the corresponding controlling plate. Each roller wheel is disposed on a bottom of the corresponding rocking plate.

### BACKGROUND OF THE INVENTION

The present invention relates to an automatic massage device. More particularly, the present invention relates to an automatic massage device which pats a user automatically.

A conventional massage device cannot pat a user automatically. A user should use a plate to pat his body manually. Therefore, a user will be weary after a long period of patting.

### SUMMARY OF THE INVENTION

An object of the present invention is to provide an automatic massage device which pats a user automatically and conveniently.

Another object of the present invention is to provide an automatic massage device which pats a user safely.

Another object of the present invention is to provide an automatic massage device which is suitable for a long period of usage.

Accordingly, an automatic massage device comprises a base panel, a transmission mechanism, and a rocking mechanism. Two pairs of posts are disposed on the base panel. Two pairs of pillars are disposed on the base panel. The transmission mechanism has a motor disposed on the base panel, a first worm, a second worm, two gears, two pairs of first bearings, two generally S-shaped push plates, two driven shafts, and the motor having a first main shaft connected to the first worm and a second main shaft connected to the second worm. Each pair of posts position the corresponding driven shaft. Each pair of first bearings are disposed on the corresponding gear. Each driven shaft passes through the corresponding generally S-shaped push plate, the corresponding pair of first bearings, and the corresponding gear. The first worm engages with the corresponding gear. The second worm engages with the corresponding gear. The rocking mechanism has two rocking plates, two pairs of second bearings, two pivot shafts, two controlling plates, two expansion springs, two chucks, two roller wheels, and two platforms. Each pair of pillars position the corresponding pivot shaft. Each platform is connected to the corresponding rocking plate. Each chuck is disposed on the corresponding platform to receive a plurality of rods. Each expansion spring is connected to the base panel and the corresponding controlling plate. Each pair of second bearings are disposed on the corresponding rocking plate. Each driven shaft passes through the corresponding pair of second bearings, the corresponding rocking plate, and the corresponding controlling plate. Each roller wheel is disposed on a bottom of the corresponding rocking plate.

### BRIEF DESCRIPTION OF THE DRAWINGS

FIG. 1 is a perspective view of an automatic massage device of a preferred embodiment in accordance with the present invention;

FIG. 2 is a top plan view of an automatic massage device of a preferred embodiment in accordance with the present invention;

FIG. 3 is a schematic view illustrating a first operation of an automatic massage device of a preferred embodiment in accordance with the present invention;

FIG. 4 is a schematic view illustrating a second operation of an automatic massage device of a preferred embodiment in accordance with the present invention; and

FIG. 5 is a schematic view illustrating a third operation of an automatic massage device of a preferred embodiment in accordance with the present invention.

### DETAILED DESCRIPTION OF THE INVENTION

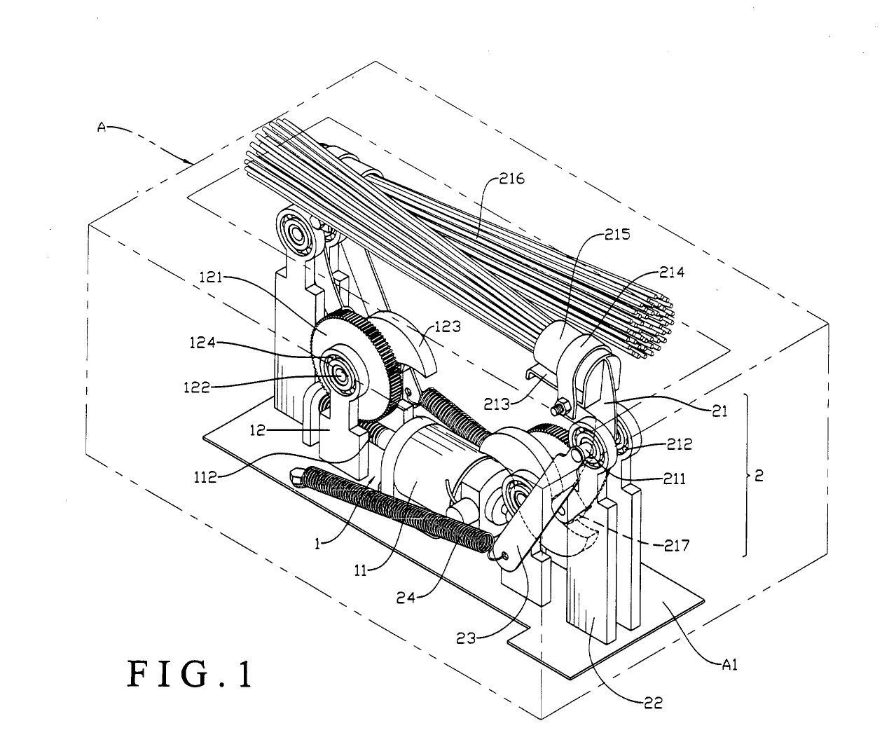

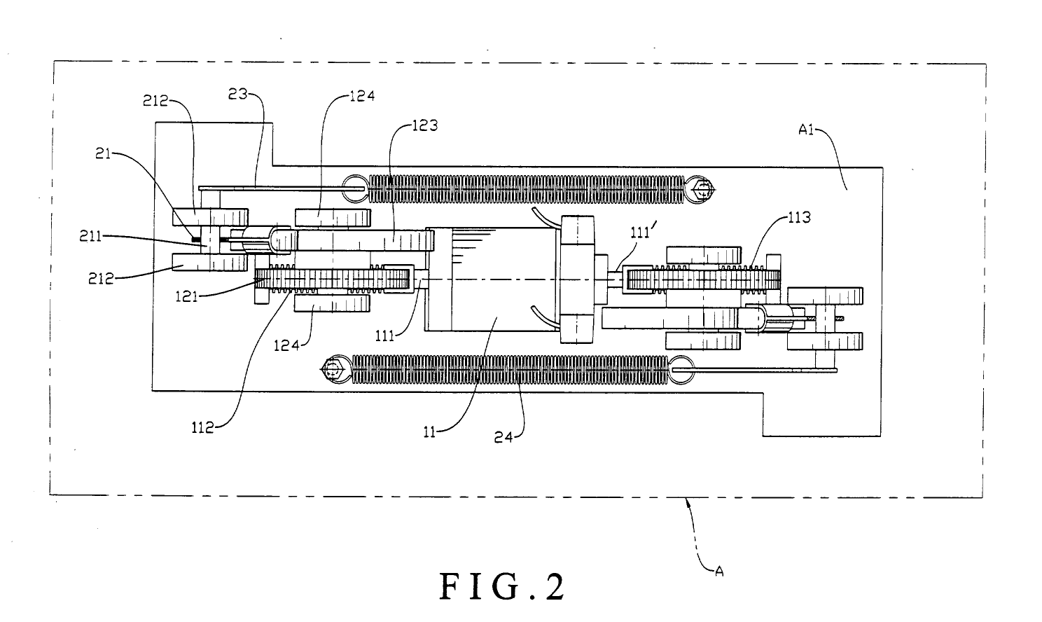

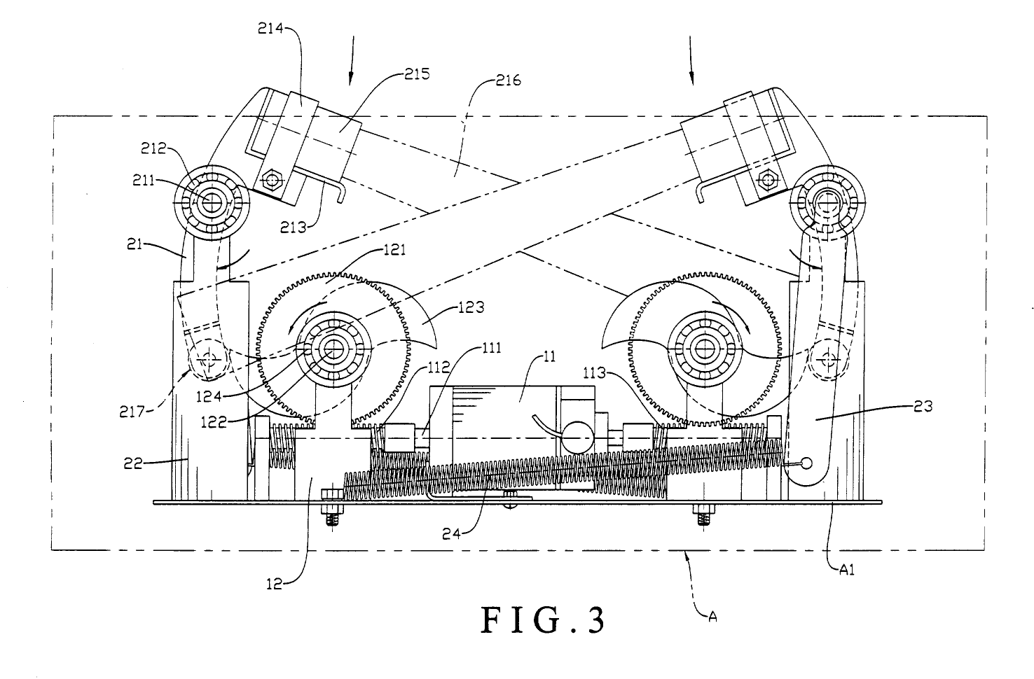

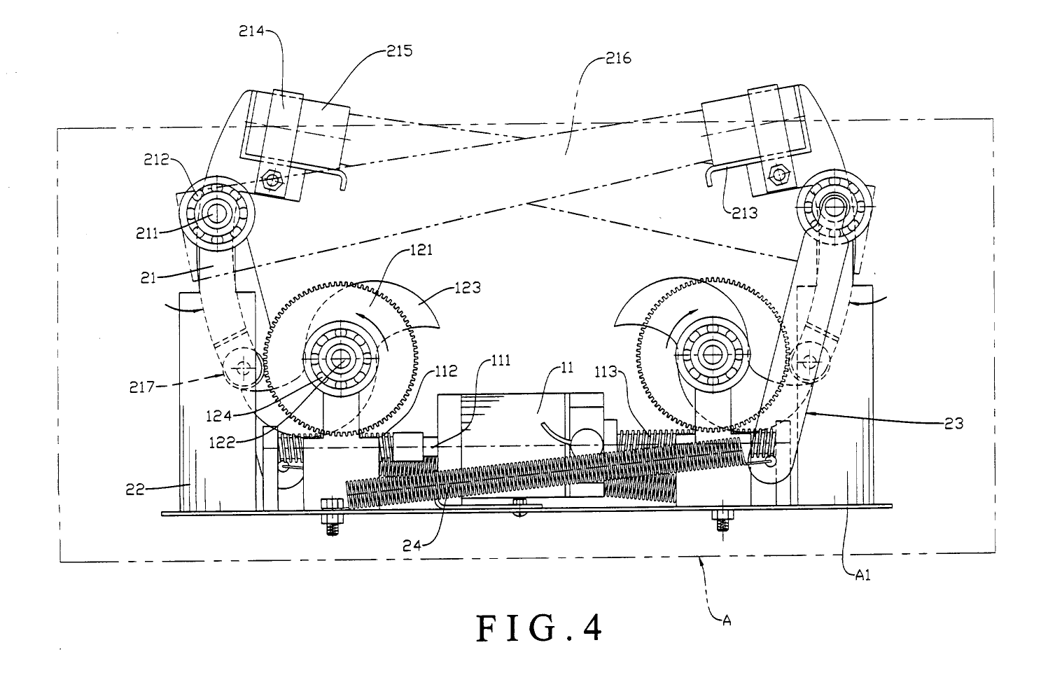

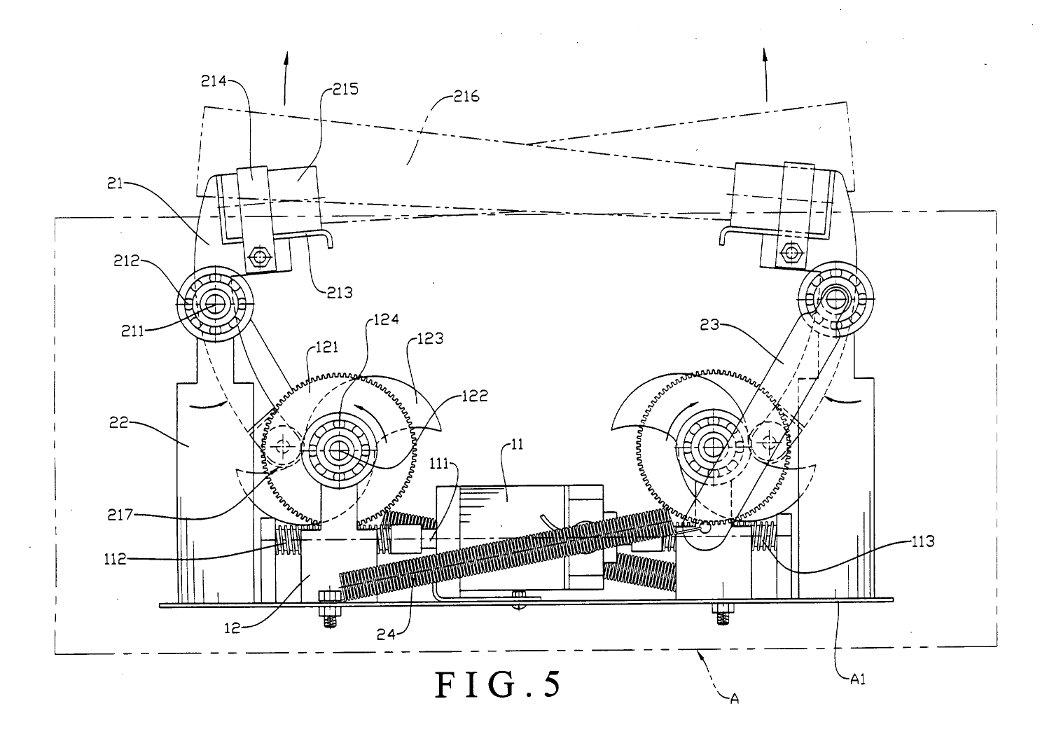

Referring to FIGS. 1 to 5, an automatic massage device comprises a base panel A1, a transmission mechanism 1, and a rocking mechanism 2.

Two pairs of posts 12 are disposed on the base panel A1.

Two pairs of pillars 22 are disposed on the base panel A1.

The transmission mechanism 1 has a motor 11 disposed on the base panel A1, a first worm 112, a second worm 113, two gears 121, two pairs of first bearings 124, two generally S-shaped push plates 123, two driven shafts 122, and the motor 11 having a first main shaft 111 connected to the first worm 112 and a second main shaft 111′ connected to the second worm 113.

Each pair of posts 12 position the corresponding driven shaft 122.

Each pair of first bearings 124 are disposed on the corresponding gear 121.

Each driven shaft 122 passes through the corresponding generally S-shaped push plate 123, the corresponding pair of first bearings 124, and the corresponding gear 121.

The first worm 112 engages with the corresponding gear 121.

The second worm 113 engages with the corresponding gear 121.

The rocking mechanism 2 has two rocking plates 21, two pairs of second bearings 212, two pivot shafts 211, two controlling plates 23, two expansion springs 24, two chucks 215, two hoops 214, two roller wheels 217, and two platforms 213.

Each pair of pillars 22 position the corresponding pivot shaft 211.

Each platform 213 is connected to the corresponding rocking plate 21.

Each chuck 215 is disposed on the corresponding platform 213 to receive a plurality of rods 216.

Each hoop 214 surrounds the corresponding chuck 215.

Each expansion spring 24 is connected to the base panel A1 and the corresponding controlling plate 23.

Each pair of second bearings 212 are disposed on the corresponding rocking plate 21.

Each driven shaft 122 passes through the corresponding pair of second bearings 212, the corresponding rocking plate 21, and the corresponding controlling plate 23.

Each roller wheel 217 is disposed on a bottom of the corresponding rocking plate 21.

When the motor 11 drives the first main shaft 111 and the second main shaft 111′ to rotate, the first worm 112 drives the corresponding gear 121 to rotate and the second worm 113 drives the corresponding gear 121 to rotate. Then each S-shaped push plate 123 pushes the corresponding roller wheel 217 to rotate so that the corresponding rocking plate 21 will rock.

When each S-shaped push plate 123 disengages from the corresponding roller wheel 217, each expansion spring 24 will force the corresponding S-shaped push plate 123 to rotate to an opposite direction.

An outer casing A receives the automatic massage device.

The present invention has the following advantages. The automatic massage device pats a user automatically and conveniently. The automatic massage device pats the user safely. Since the bearings decrease a friction of the automatic massage device, the automatic massage device is suitable for a long period of usage. Each S-shaped push plate has a smooth curved shape in order to push the corresponding roller wheel smoothly.

The present invention is not limited to the above embodiment but various modification thereof may be made. Furthermore, various changes in form and detail may be made without departing from the scope of the present invention.

I claim:

1. An automatic massage device comprises:
a base panel, a transmission mechanism, and a rocking mechanism,
two pairs of posts disposed on the base panel,
two pairs of pillars disposed on the base panel,
the transmission mechanism having a motor disposed on the base panel, a first worm, a second worm, two gears, two pairs of first bearings, two generally S-shaped push plates, two driven shafts, and the motor having a first main shaft connected to the first worm and a second main shaft connected to the second worm,
each said pair of posts positioning the corresponding driven shaft,
each said pair of first bearings disposed on the corresponding gear,
each said driven shaft passing through the corresponding generally S-shaped push plate, the corresponding pair of first bearings, and the corresponding gear,
the first worm engaging with the corresponding gear,
the second worm engaging with the corresponding gear,
the rocking mechanism having two rocking plates, two pairs of second bearings, two pivot shafts, two controlling plates, two expansion springs, two chucks, two roller wheels, and two platforms,
each said pair of pillars positioning the corresponding pivot shaft,
each said platform connected to the corresponding rocking plate,
each said chuck disposed on the corresponding platform to receive a plurality of rods,
each said expansion spring connected to the base panel and the corresponding controlling plate,
each said pair of second bearings disposed on the corresponding rocking plate,
each said driven shaft passing through the corresponding pair of second bearings, the corresponding rocking plate, and the corresponding controlling plate, and
each said roller wheel disposed on a bottom of the corresponding rocking plate.
